(19) United States
(12) Patent Application Publication
(10) Pub. No.: US 2023/0232854 A1
(43) Pub. Date: Jul. 27, 2023

(54) METHOD TO PREPARE BEVERAGES AND BEVERAGES THUS OBTAINED

(71) Applicant: STEAMPOWER INNOVATIVA S.R.L., Verona (IT)

(72) Inventor: Gianpaolo Facco, Camposampiero (IT)

(73) Assignee: STEAMPOWER INNOVATIVA S.R.L., Verona (IT)

(21) Appl. No.: 17/999,372

(22) PCT Filed: May 20, 2021
(86) PCT No.: PCT/IT2021/050150

§ 371 Date: Nov. 18, 2022

(30) Foreign Application Priority Data
May 21, 2020 (IT) 202000011815

(51) Int. Cl. A23F 5/26; A23F 5/08

(52) U.S. Cl. CPC A23F 5/26; A23F 5/08

(57) ABSTRACT

The method to prepare flavored beverages comprises a step (110) of putting a substrate (20) in contact with an extraction liquid (30), wherein the substrate (20) is immersed in the extraction liquid (30). The substrate is of vegetable origin and can be of toasted or dried grain type, toasted or dried spices, or toasted or dried fruit. The extraction liquid can be water, milk or other food beverage.

### FIELD OF THE INVENTION

The present invention concerns a method to prepare flavored beverages and the flavored beverages thus obtained. In particular, the flavored beverages to which the described embodiments refer are obtained by extraction, by means of an extraction liquid or fluid, from any type of toasted or dried grain, toasted or dried spices, or from toasted or dried fruit, as well as the beverages derived from them.

### BACKGROUND OF THE INVENTION

Flavored beverages obtained from grains, spices or toasted or dried fruit have long been known, among which the best known is coffee.

Different methods are known for preparing coffee, which all comprise two distinct steps.

Almost 900 substances have been identified in the coffee seed, the most important of which are water, proteins and amino acids, lipids, carbohydrates and minerals. Among the minerals, potassium, calcium and magnesium are present in higher concentrations.

Known methods provide a first step of dry grinding of the roasted coffee beans, by fraction or impact, intended to increase the exchange surface between the coffee and the extraction liquid (usually water) in order to improve the extraction of the soluble substances contained in the beans.

The size of the particles obtained from dry grinding has an impact on the preparation of the beverage. Finer particles contribute to a more effective extraction, while coarser particles ensure good outflow of the extraction liquid.

After the dry grinding step, a second step of extracting the beverage from the ground product produced in the first step is carried out. To date, three different types of processes are known for extracting coffee with water.

Extraction by percolation, or dripping, provides that the water passes through the ground coffee located in a filter by gravity, drawing the extracted aromatic substances with it. Among the methods based on this process are V60, Chemex, Neapolitan coffee or cold extraction.

The second type of process is known as pressure extraction, and provides that the water or water vapor passes through the ground coffee located in a filter, with pressures higher than atmospheric pressure. The methods or devices such as mocha, espresso, syphon or aeropress use this process. Among these methods, espresso is particularly widespread and appreciated as it allows to obtain a very strong, concentrated and full-bodied beverage, with a more complex structure and a layer of cream that covers the liquid.

Finally, extraction by infusion provides to leave the ground coffee immersed in water for a time usually of a few minutes, and then possibly filtering. The methods of Turkish coffee, Arabian coffee or the French press use this process.

One disadvantage of known extraction methods lies in the difficulty of obtaining a surface cream during extraction, which is so popular with consumers. As mentioned above, espresso is the only method that makes it possible to obtain the cream, but the cream obtained is in any case little (usually representing about 10% of the beverage obtained) and not very durable, as it disappears by itself after a few minutes.

Another disadvantage of known methods lies in the initial dry grinding step, which entails the loss of various volatile aromatic substances initially contained in the coffee beans, oxidative acceleration of the oils, irregularities in the grain size. The losses of volatile aromatic substances are due to the heat that develops in the grinding devices, in particular in electric grinders, and which can induce Maillard reactions that worsen the organoleptic qualities of the coffee-based beverage.

Another disadvantage of known extraction methods lies in the inefficiency of extracting coffee from the powder. It is estimated that known methods allow to extract about 30% of the substances contained in the beans.

For example, it has been possible to verify that, among the various substances contained in coffee seeds, potassium is extracted but the other minerals remain in the coffee grounds, a large part of the lipids or fats is retained in the filter, the proteins and amino acids are lost during roasting, as well as the soluble carbohydrates, while the insoluble carbohydrates undergo a transformation.

Another disadvantage of known methods is precisely the coffee grounds that, in addition to keeping many substances trapped, represent a considerable amount of waste.

There is therefore a need to perfect a method to prepare flavored beverages which can overcome at least one of the disadvantages of the state of the art.

In particular, one purpose of the present invention is to perfect a method to prepare flavored beverages which is more effective in terms of extracting the substances contained in the food stuffs from which the beverages are obtained.

Another purpose is to perfect a method to prepare flavored beverages which allows to obtain beverages with a larger and more resistant creamy part than known beverages.

Another purpose is to perfect a method to prepare flavored beverages which allows to reduce the waste of original food material.

Yet another purpose is to provide a flavored beverage with improved organoleptic properties compared with known flavored beverages, in particular in terms of structure and complexity of the aromas.

Yet another purpose is to provide a flavored beverage more concentrated in aromatic and nutritional substances originally contained in the starting food material.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, hereafter there is described a method to prepare flavored beverages and some flavored beverages obtained with such method, which overcome the limits of the state of the art and eliminate the defects present therein.

In accordance with some embodiments, there is provided a method to prepare flavored beverages which provides an extracting step, in which a food substrate in an incoherent form and an extraction liquid are put in contact. Preferably, putting the substrate in contact with the extraction liquid provides immersing the substrate in the extraction liquid.

The food substrate in an incoherent form is preferably of vegetable origin. In other words, the substrate is preferably obtained starting from vegetable foodstuffs.

The preparation method provides a step of emulsifying the beverage. Preferably, the emulsifying is obtained by mechanical action on the extraction liquid. More preferably, the emulsifying is performed after the step of putting the substrate in contact with the extraction liquid.

According to some embodiments, the substrate is not previously ground. In this case, the preparation method provides a step of grinding the substrate. Preferably, the step of grinding the substrate occurs after the step of putting the substrate in contact with the extraction liquid. More preferably, the grinding of the substrate occurs while the latter is immersed in the extraction liquid.

Advantageously, the grinding of the substrate is performed by means of mechanical cutting and/or cavitation.

More advantageously, the cavitation is performed by means of acoustic and/or ultrasonic waves.

Even more advantageously, the mechanical cutting and the cavitation occur simultaneously.

In a preferential manner, the grinding of the substrate results in a granulometry smaller than or equal to 100 microns, preferably smaller than or equal to 50 microns, more preferably smaller than or equal to 10 microns, even more preferably smaller than or equal to 5 microns.

According to some embodiments, the preparation method also provides a step of filtering the substrate from the extraction liquid.

According to one aspect, there is also provided a flavored beverage that can be obtained by means of the method described above.

Preferably, the beverage consists of at least 20% by volume of froth. More preferably, the froth is obtained by emulsifying the extraction liquid. Even more preferably, the beverage consists of froth for a proportion comprised between 20% and 90% by volume.

According to some embodiments, the flavored beverage also comprises one or more additives able to improve its organoleptic properties and/or appearance.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a diagram of a method according to embodiments described here.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the possible embodiments of the invention, of which one or more non-limiting examples are shown in the attached drawings. The phraseology and terminology used here are also for the purposes of providing non-limiting examples.

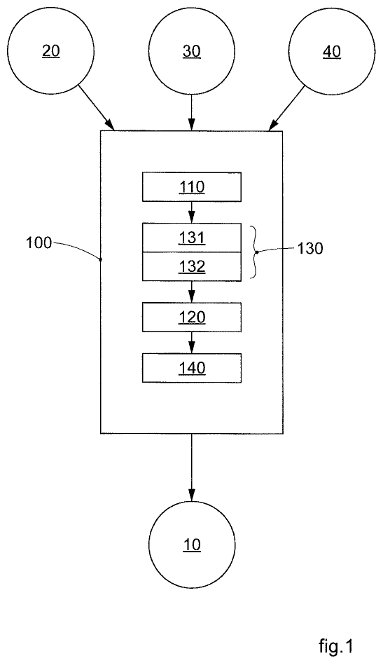

The method to prepare flavored beverages is schematically shown in FIG. 1. The flavored beverages 10 obtainable by means of the method are of the type extracted from a food substrate 20 in an incoherent form by means of an extraction liquid 30.

In particular, the preparation method according to the invention is provided to extract beverages from one or more food substrates in an incoherent form. In particular, the substrates in an incoherent form can be in the form of grains, beans, seeds, fruits, leaves, rhizomes or other parts of plants suited to the purpose. For example, the substrates in an incoherent form can be of the roasted or dried grain or bean type (for example: coffee, barley, corn, rice, wheat, sorghum, millet, oats, triticale, rye, fonio, quinoa, cocoa, cola), roasted or dried spices (for example: tea, anise, cinnamon, cardamom, cloves, ginseng, ginger, yerba mate, guarana, chamomile, thyme, lemon balm, juniper, marjoram, saffron, turmeric, licorice, rosemary, eucalyptus, mint, coriander, cumin, nutmeg, paprika, pepper, chili, fennel seeds, poppy seeds, mustard, sesame, tamarind, vanilla, myrtle, oregano, sage, parsley, leek, garlic, lavender, hyssop, tarragon, calendula, caper), or roasted or dried fruit (for example: apricot, pineapple, cherry, kiwi, fig, apple, mango, coconut, melon, blueberry, papaya, peach, pear, plum, banana, raisin, citrus, walnut, hazelnut, cashew, almond, peanut, date, pine nut, pistachio).

The extraction liquid is an edible liquid that can be used to prepare flavored beverages. Typically, the extraction liquid 30 is water, however other types of ingestible or edible liquids or beverages can also be provided, for example milk of animal origin, beverages of vegetable origin, other water-based beverages or a mixture of one or more of them.

The method to prepare beverages is centered on a step 100 of extraction during which the substances contained in the substrate 20 are extracted by means of the extraction liquid 30. The step 100 of extraction is divided into at least two sub-steps, a sub-step 110 of putting the substrate 20 in contact in the extraction liquid 30, and a sub-step 120 of emulsifying the extraction liquid 30.

The contacting sub-step 110 provides to immerse the substrate 20 in the extraction liquid 30. In this way, the extraction of the substances of interest from the substrate 20 begins, particularly if the substrate 20 is in the ground form.

Advantageously, the emulsifying sub-step 120 is performed after the contacting sub-step 110, while the substrate 20 is immersed in the extraction liquid. The emulsifying occurs preferably by mechanical action applied to the extraction liquid 30.

According to one variant, the mechanical action for the emulsifying is performed by means of one or more blades rotating in the liquid at high speed, for example of the type of a mixer. Alternatively, the mechanical emulsifying can be performed with other means, for example a filter that is displaced inside the extraction liquid 30, at speed and along a predetermined path such as to cause the emulsifying of the liquid.

For a greater efficacy of the emulsifying, it is preferable that this step occurs when the substances of interest have been extracted from the substrate 20. In order for these substances to be extracted from the substrate 20, it is advantageous for this to have been previously ground, or crushed.

The emulsifying sub-step 120 allows to obtain a flavored beverage with a higher frothy component compared to known beverages.

By way of example, considering a coffee beverage, the method according to the invention allows to obtain a beverage with at least 20% froth, by volume, which is greater than the proportion of froth in known coffee beverages (at most 10%). Tests have allowed to establish that, with the method as above, it is possible to obtain coffee beverages with higher percentages of froth, for example 30%, 40%, 50%, 60%, 70% and even up to 80% by volume of froth. The rest of the beverage is the liquid part, that is, the extraction liquid 30 with the substances extracted from the substrate 20.

The embodiment of the method shown in FIG. 1 provides that during the immersing sub-step 110, the substrate 20 is still whole. There is therefore provided a sub-step 130 of grinding the substrate 20 in the extraction liquid 30.

The fact of performing the grinding of the substrate 20 in the extraction liquid 30 entails several advantages, the first of which being performing the preparation of the flavored beverage in a single step, instead of in two in known methods.

Another advantage of performing the grinding in the extraction liquid lies in the fact that the substances, in particular the volatile ones, which are released the moment the substrate is ground, are directly solubilized in the extraction liquid. In other words, the loss of substances present in the substrate is reduced, which makes it possible to obtain a flavored beverage with a higher content of nutrients and aromas.

In accordance with some embodiments, and regardless of whether the grinding occurs dry or in the extraction liquid 30, the preparation method provides that the substrate 20 is ground, or crushed, so as to obtain a substrate powder with granulometry smaller than 500 microns, for example 400, 300, 200, 100, 50, 10, 5 microns or less.

This technical aspect also has several advantages, including a greater effectiveness in the extraction of nutrients and aromas. The improved extraction is explained by the greater contact surface between the substrate and the extraction liquid, precisely because of the smaller granulometry.

Another advantage of the smaller granulometry lies in the reduction, if not the elimination, of waste such as coffee grounds, for example.

It has been observed that these advantages are even more felt when the grinding occurs in the extraction liquid 30. The grinding in a liquid environment allows to obtain very small granulometries, typically less than 10 microns.

According to some embodiments, the grinding, or crushing, sub-step 130 provides both a mechanical cutting 131 of the substrate 20 and also a cavitation 132 of the substrate. The cutting 131 and cavitation 132 preferably occur simultaneously, so as to improve the crushing and obtain a smaller granulometry in a shorter time.

More precisely, the suspension of the substrate 20 in the extraction liquid 30 is subjected to shear forces which, with a high efficiency of disintegration of the solid matrix of the substrate 20, and maximization of the access area of the extraction liquid 30, allow to obtain an exhaustion of the matrix.

The suspension is also subjected to pressure waves and cavitation effects, which generate microjets directed for example toward a solid surface of the container in which the step 100 of extraction occurs in its entirety. These microjets cause the rupture of the walls of the cells contained in the substrate 20 and the release of the substances contained therein.

Controlled cavitation, in particular in the extraction liquid 30, increases mass transfer and diffusive phenomena, which allows to optimize the extraction of the substances contained in the substrate 20.

Similar results can be obtained through the use of ultrasonic mechanical forces. The high energy ultrasonic waves travel through the extraction liquid 30 creating alternating high pressure/low pressure cycles, which results in an acoustic cavitation phenomenon.

Acoustic, or ultrasonic, cavitation locally leads to very high temperatures, pressures, heating and cooling rates, pressure differentials and high shear forces in the extraction liquid 30.

When the cavitation bubbles implode on the surface of the solids, the microjets and the collision between substrate particles generate effects such as surface peeling, erosion, rupture of the particles, sonoporation and rupture of the cells.

Furthermore, the implosion of cavitation bubbles in liquid media creates macro-turbulences and micro-mixing. Ultrasonic irradiation is an efficient way to improve mass transfer processes, since sonication causes cavitation and its correlated mechanisms, such as micro-movement by liquid jets, compression and decompression in the material with the resulting cell wall rupture, as well as high heating and cooling rates.

It should be noted that during the sub-steps 110, 120, 130 described above and which make up the extracting step 100, it is possible to provide that the extraction liquid 30 is heated, so as to perform the step 100 of extraction hot. For example, the step 100 of extraction can be performed at a temperature of 60° C. or more.

With reference again to FIG. 1, the preparation method provides, after the emulsifying sub-step 120, a filtering sub-step, aimed at removing any waste from the extraction liquid 30.

This filtering sub-step 140 is optional, and can even be performed, if provided, before the emulsifying sub-step 120. In this case, the emulsifying would occur in the absence of the substrate 20 in the extraction liquid 30, but in any case, in the presence of the substances previously contained in the substrate 20.

We wish to point out that the absence of the filtering sub-step 140 has the advantage of not having waste at the end of the preparation of the flavored beverage 10.

In alternative embodiments to the one described above, the substrate 20 is ground before the immersing sub-step 110. In this case, after the contacting sub-step 110, the grinding sub-step 130 is not performed, and the emulsifying sub-step 120 is performed directly.

It has been possible to verify that the preparation method in accordance with the invention is well suited for preparing coffee (that is, wherein the substrate 20 is roasted coffee beans, and the extraction liquid 30 is water), since it solves several problems linked to the known methods to prepare coffee, including the dry grinding step and the consequent loss of nutrients and organoleptic properties, a greater extraction efficiency, as well as a reduction in waste.

The method has also proved particularly well suited for preparing cappuccino, with coffee beans as the substrate 20, and milk as the extraction liquid 30.

The preparation of a cappuccino in accordance with the method as above has various advantages, in particular that of supplying an abundant and lasting froth. Milk froth is in fact an essential element of a cappuccino.

Another advantage is that, since the coffee is ground directly in the milk, the dilution caused by the introduction of water in traditional cappuccinos, the preparation of which provides to pour milk with froth into a volume of coffee (made with water), is prevented.

In some way, the preparation method according to the invention is like making an instant cappuccino but based on coffee only.

According to some embodiments, it is also possible to provide the addition of additive substances 40 such as, for example, flavorings, coloring agents, emulsifiers or suchlike.

It is clear that modifications and/or additions of parts or steps may be made to the method to prepare flavored beverages as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. A method to prepare flavored beverages, comprising a step of putting a food substrate in an incoherent form in contact with an extraction liquid, wherein said substrate is immersed in said extraction liquid, and, after said contacting step, a step of emulsifying the extraction liquid.

2. The method as in claim 1, wherein the emulsifying step occurs while the substrate is still immersed in the extraction liquid.

3. The method as in claim 1, wherein the emulsifying step is obtained by mechanical action on the extraction liquid.

4. The method as in claim 3, comprising a grinding step before the emulsifying step and while the substrate is immersed in the extraction liquid.

5. The method as in claim 4, wherein the grinding step is carried out by mechanical cutting and/or cavitation.

6. The method as in claim 5, wherein the mechanical cutting and the cavitation occur simultaneously.

7. The method as in claim 5, wherein the cavitation is performed with acoustic waves and/or ultrasonic waves.

8. The method as in claim 1, wherein the substrate is in the form of a powder with a granulometry smaller than 500 microns.

9. The method as in claim 1, wherein the substrate comprises roasted coffee and the extraction liquid comprises water or milk.

10. A flavored beverage obtainable with the preparation method of claim 1, the flavored beverage comprising a liquid portion and a frothy portion, wherein the frothy portion represents at least 20% by volume of the flavored beverage.

11. The method as in claim 6, wherein the cavitation is performed with acoustic waves and/or ultrasonic waves.

12. The method as in claim 2, wherein the emulsifying step is obtained by mechanical action on the extraction liquid.
